(19) United States
(12) Patent Application Publication
(10) Pub. No.: US 2004/0065008 A1
(43) Pub. Date: Apr. 8, 2004

(54) Methods for storing tree seedlings

(76) Inventor: Michael J. Pfaff, Centralia, WA (US)

Correspondence Address: WEYERHAEUSER COMPANY, INTELLECTUAL PROPERTY DEPT., CH 1J27, P.O. BOX 9777, FEDERAL WAY, WA, 98063, US

(21) Appl. No.: 10/265,008

(22) Filed: Oct. 3, 2002

(51) Int. Cl. A01B 79/02

(52) U.S. Cl. 47/58.1 SE

(57) ABSTRACT

In one aspect, the present invention provides methods for storing tree seedlings. The methods of this aspect of the invention each include the steps of (a) freezing a population of tree seedlings wherein each seedling within the population includes a root mass that includes roots and a growth medium, the roots being disposed within the growth medium, wherein the root mass is disposed within a container; and (b) storing the frozen seedlings at a temperature at which the seedlings remain frozen.

### FIELD OF THE INVENTION

The present invention relates to methods for storing tree seedlings, wherein the tree seedlings are frozen prior to being planted into a growth medium, such as soil.

### BACKGROUND OF THE INVENTION

During the commercial cultivation of many tree species, seedlings are first grown in a greenhouse, or other controlled-environment facility, and are then stored before being transported and planted into the soil in a forest, or other growth site. The amount of time that a seedling can be stored above freezing temperature is limited because of damage to the seedling due to microbial infection. Some tree species, such as firs and pines, can be frozen during storage to reduce, or prevent, damage due to microbial infection. One drawback to this approach, however, is that, when the seedlings are thawed prior to planting, thawing may take several days, and the rate of thawing varies amongst the seedlings in a frozen population. Additionally, the soil that covers the roots of the stored seedlings may become wet, and detach from the roots as the thawing process continues. Further, it is often difficult to separate the root masses of adjacent, frozen, seedlings.

There is, therefore, a need for methods for storing tree seedlings that limit, or eliminate, damage to the seedlings due to microbial infection during storage; preserve the physical integrity of the root mass during storage and planting; and allow the stored seedlings to be individually manipulated and planted. The present inventors have unexpectedly discovered that it is possible to accomplish the foregoing objectives by individually disposing the root mass of each tree seedling within separate containers before freezing the seedlings.

### SUMMARY OF THE INVENTION

In one aspect, the present invention provides methods for storing tree seedlings. The methods of the invention each include the steps of (a) freezing a population of tree seedlings wherein each seedling within the population includes a root mass that includes roots and a growth medium, the roots being disposed within the growth medium, wherein the root mass is disposed within a container; and (b) storing the frozen seedlings at a temperature at which the seedlings remain frozen. The population of frozen seedlings may be stored frozen for a desired period of time prior to planting the seedlings at a growth site, such as in a tree nursery or forest. The methods of this aspect of the invention are useful in any situation in which it is desired to store tree seedlings. Thus, for example, the methods of this aspect of the invention are useful for storing pine and fir tree seedlings until they are transported to a growth site where they will be cultivated to yield pine or fir trees that can be harvested to make wood products. An advantage of the methods of this aspect of the invention is that individual seedlings within a stored, frozen, population can be readily separated and planted.

In another aspect, the present invention provides methods for planting tree seedlings. The methods of this aspect of the invention each include the steps of (a) freezing a population of tree seedlings wherein each seedling within the population includes a root mass that includes roots and a growth medium, the roots being disposed within the growth medium, wherein the root mass is disposed within a container; and (b) planting the frozen seedlings into a growth substrate (e.g., soil in a tree nursery or forest). The methods of this aspect of the invention may optionally include the step of storing the frozen seedlings (at a temperature at which the stored seedlings remains frozen) prior to planting. The methods of this aspect of the invention are useful for planting tree seedlings, such as pine or fir tree seedlings. An advantage of the methods of this aspect of the invention is that individual seedlings within a stored, frozen, population can be readily separated and planted.

### DETAILED DESCRIPTION OF THE PREFERRED EMBODIMENT

In one aspect, the present invention provides methods for storing tree seedlings. The methods of this aspect of the invention each include the steps of (a) freezing a population of tree seedlings wherein each seedling within the population includes a root mass that includes roots and a growth medium, the roots being disposed within the growth medium, wherein the root mass is disposed within a container; and (b) storing the frozen seedlings at a temperature at which the seedlings remain frozen.

As used herein, the term “population of tree seedlings” means at least two tree seedlings. Typically, a population of tree seedlings treated in accordance with the present invention includes at least one hundred tree seedlings, and more typically includes at least one thousand tree seedlings. The methods of the present invention can be used to store hundreds of thousands of tree seedlings. Thus, a population of tree seedlings treated in accordance with the present invention can include more than one hundred thousand tree seedlings, or can include more than one million tree seedlings, or more than ten million tree seedlings, or more than twenty million tree seedlings. An exemplary range for the number of tree seedlings that can be treated in accordance with the methods of the invention is from one thousand tree seedlings to fifty million tree seedlings.

Typically, during the commercial production of trees, seedlings are grown from seed in a greenhouse, or other controlled environment facility, and are then stored before being transported and planted into the soil in a tree plantation, or other outdoor growth site. In the practice of the present invention, tree seedlings are typically grown for a period of from six months to one and a half years before being frozen and stored. Preferably, tree seedlings are in a dormant growth state, and are capable of surviving an ambient temperature of −3° C., before they are frozen in accordance with the methods of the invention.

The roots of seedlings are usually disposed within a mass of growth medium, typically soil, during storage. The term “soil” encompasses both natural and synthetic soils. The roots and growth medium together form the root mass. Individual seedlings are typically stored in close physical proximity to other seedlings so that the root mass of each individual seedling is adjacent to the root mass(es) of at least one other seedling. If the seedlings are frozen during storage then the root masses of adjacent seedlings tend to freeze together, and it is difficult to separate the frozen root masses when it is time to plant the seedlings. Further, thawing the frozen root masses prior to planting often renders the root masses wet and unstable, and subject to damage when they are handled during the planting process.

In the practice of the present invention, the root mass of a tree seedling is placed within a container, and then the seedling (including the root mass) is frozen. Numerous seedlings (each having its root mass disposed within a container) may be grouped together prior to freezing, or the seedlings may be frozen and then grouped together. An advantage of the present invention is that, when seedlings are grouped together and frozen, the containers within which the root masses are disposed prevent adjacent root masses from sticking together during freezing and/or storage. Thus, an operator can readily separate the frozen seedlings when it is time to plant the seedlings.

Moreover, utilizing the methods of the present invention, the frozen seedlings can be planted into a growth medium, typically soil, without having to thaw the root masses before planting, thereby avoiding disassociation of the root masses during the thawing and planting processes. If desired, however, the root masses may be completely or partially thawed prior to planting. The container may, or may not, be removed from the root mass before the root mass is planted into the growth medium.

The methods of the present invention can be used to store seedlings of any tree species, such as Douglas fir, Western Hemlock, Noble fir, Western Red Cedar, Fraser fir, Canaan fir, Balsam fir, Grand fir, Red Alder, Sitka spruce, and all pine species.

In some embodiments of the present invention, tree seedlings are frozen at a temperature below 1° C., such as below 2° C., or such as below 3° C. A typical temperature range used to freeze tree seedlings in the practice of the invention is between minus 1° C. and minus 5° C. The frozen seedlings are stored at a temperature at which the seedlings remain frozen, typically between minus 1° C. and minus 5° C. Frozen tree seedlings are typically stored for a period of from one month to six months, although the frozen seedlings may be stored for longer than six months if desired (e.g., for a period in the range of from six months to two years, or for a period in the range of from six months to three years, or for a period in the range of from six months to four years).

Containers can be made from any material that is not fatally toxic to the roots of the seedling, and that permits the egress of the growing roots after the seedling is planted into the soil, or other growth substrate. Some containers useful in the practice of the present invention are biodegradable. Thus, for example, bags, such as paper bags, and containers made from wood pulp, are useful in the practice of the invention. By way of specific example, wax-coated paper bags, such as those manufactured by Poly-Bag, Inc. (4301 South Tacoma Way, Tacoma, Wash. 98409), are useful in the practice of the present invention.

The root masses of individual seedlings are usually each disposed within a container before the seedlings are grouped together and frozen. The process of disposing seedlings into containers can be fully or partially automated. For example, seedlings can be removed from their growth containers by hand, or by using a pin extractor. The seedlings can then be graded (e.g., to remove sickly or otherwise undesirable seedlings) and disposed, by automated mechanical means, into containers, and then transported on a conveyor belt to a site where they are frozen. In some embodiments of the invention, however, the root masses are first frozen and then individually disposed within containers.

In some embodiments of the invention, the growth medium within which the roots are disposed prior to freezing, and during freezing, includes fertilizer, such as delayed release fertilizer which releases nutrients over an extended time period of weeks or months. The fertilizer provides seedlings with nutrients during the first growing season after the seedlings are planted at a growth site.

In another aspect, the present invention provides methods for planting tree seedlings. The methods of this aspect of the invention each include the steps of (a) freezing a population of tree seedlings wherein each seedling within the population includes a root mass that includes roots and a growth medium, the roots being disposed within the growth medium, wherein the root mass is disposed within a container; and (b) planting the frozen seedlings into a growth substrate (e.g., soil in a tree nursery or forest). The number of seedlings that can be treated in accordance with this aspect of the invention, the conditions for freezing the seedlings, and the properties of containers useful in the practice of this aspect of the present invention, are as described, supra, in connection with the methods for storing tree seedlings. In the practice of this aspect of the present invention, the growth substrate is typically natural or synthetic soil, and the frozen seedling is typically planted in an outdoor growth site, such as a tree nursery, forest, or other tree plantation.

The methods of the present invention for planting one or more tree seedlings may optionally include the step of storing the frozen seedlings, at a temperature at which the stored seedlings remains frozen, prior to planting. Thus, in some embodiments, the present invention provides methods for planting tree seedlings, wherein the methods of this aspect of the invention each include the steps of (a) freezing a population of tree seedlings wherein each seedling within the population includes a root mass that includes roots and a growth medium, the roots being disposed within the growth medium, wherein the root mass is disposed within a container; (b) storing the frozen seedlings at a temperature at which the frozen seedlings remain frozen; and (c) planting the frozen seedlings into a growth substrate (e.g., soil in a tree nursery or forest). The frozen seedlings are stored at a temperature at which the seedlings remain frozen, typically between minus 1° C. and minus 5° C. Frozen tree seedlings are typically stored for a period of from one month to six months, although the frozen seedlings may be stored for longer than six months if desired, as described, supra, in connection with the methods of the invention for storing tree seedlings.

The following example merely illustrates the best mode now contemplated for practicing the invention, but should not be construed to limit the invention.

### EXAMPLE 1

This Example shows that, one growth season after planting, the survival rate and vigor of Douglas fir seedlings planted while their root masses were frozen was almost identical to the survival rate and vigor of Douglas fir seedlings which had not been frozen. The experiments reported in this Example also show that packaging individual root masses in bags, before freezing and storing the frozen seedlings, facilitates separation of the individual plants at the planting site while the root masses remain frozen.

Plant material: One-year-old Douglas fir seedlings were used. Three families of Douglas fir seedlings were utilized, and were designated 300, 1022 and 1. Three families were included in the design to increase the scope of inference. Families were not included as a source of variance in the statistical analysis.

Packing: Six blocks of seedlings (each block containing about 45 seedlings) from each of the three families were selected from production populations. Selections were made at random, but abnormal or unhealthy stock was avoided. Each packable seedling was extracted and placed individually into a 6.75×7.25-inch white, cold, wax-coated paper bag manufactured by Poly-Bag, Inc. Then seedlings were divided into two groups of equal size and packed in Kraft-poly seedling storage bags (sold by Portco Packaging, 4200 Columbia Way, Vancouver, Wash. 98661). One group was placed in a cooler (the temperature was above 0° C.), and the other group was placed in a freezer (the temperature was below 0° C.).

Planting: The design structure for the planting trial was a randomized complete block. There were two sites, one at Mima and the other at Bunker Hill, both in Washington State, and each site was divided into two sections.

At Mima, two sections of bed, approximately 36 feet long, were selected and prepared by weeding and bedding. Each family was planted into each section giving 6 blocks at each site. Within each treatment group, 15 seedlings were planted in three rows of five trees each running across the bed. Rows were about one foot apart. These groups were the experimental units.

At Bunker Creek, a fenced test site was selected. Again, two sections were selected inside the test site, each occupying a different microenvironment. The treatment layout was the same as for the Mima trial (6 blocks) except that each treatment was a 15-tree row plot rather than a 15-tree block plot. Trees were planted about 2 feet apart in rows about 3 feet apart. Each row plot was an experimental unit.

Treatment Structure: The treatment structure was a 2×2 full factorial of storage method and bagging. Storage and bagging treatments were as follows: Frozen, planted with bag; Frozen, planted without bag; Cooler, planted with bag; and Cooler, planted without bag.

Assessment and Outcome Criteria: Main outcome criteria were vigor (characterized using the 5-point scale shown in Table 1) and height growth.

TABLE 1
Vigor codes used in the present study.

| Vigor Code | Description |
|---|---|
| 1 | Green needles, no loss of foliage. |
| 2 | Green needles, >75% foliage retention. |
| 3 | Some chlorosis, >50% needle retention. |
| 4 | Chlorotic, dying. |
| 5 | Dead |

Seedlings were planted in February 2000, and vigor and height growth were determined in late September 2000. Survival was calculated as the sum of Vigors 1, 2 and 3 trees. High vigor trees were those with Vigor scores of 1 and 2. Height growth was calculated as the difference between initial height (determined from position of initial terminal bud scar) and final height. In November 2000, samples of five trees from each experimental unit were excavated and the dry biomass of the roots and aerial parts (stems and leaves) were measured separately.

Statistical analysis The following two Null Hypotheses were tested: Hₒ(1), Planting one-year-old Douglas fir with frozen plugs does not affect first year vigor, growth or biomass allocation; Hₒ(2), Planting one-year-old Douglas fir with bags remaining on the plugs does not affect first year vigor, growth or biomass allocation. Two ANOVA models were used to analyze the study. One ANOVA was used to analyze the entire study, and a second ANOVA was used to analyze the sites separately. ANOVAs were run on plot means. Means were separated using Bonferroni's Procedure at Alpha=0.05.

Results: Root masses frozen within bags were easily separated by hand on the planting site while they remained frozen. The bags were also relatively easy to remove from the plugs, especially after the plugs had begun to thaw slightly. The bags covering the unfrozen root masses had deteriorated substantially by planting time. The frozen root masses were extremely easy to plant using only one hand, as the hard root mass dropped cleanly into the planting hole with little trouble. There was no practical difference between planting frozen stock with the bags disposed over the root masses, or with the bags removed.

Survival, vigor, height and growth: Survival was very high on both sites, ranging from 96.7% to 100% across treatments (Table 2), and was not affected by site or treatment. The abbreviation S.E. used in Table 2 means standard error.

TABLE 2
Mean survival and percent of high vigor trees at
both sites by treatment.

| | | | Survival | | High vigor | |
|---|---|---|---|---|---|---|
| Site | Storage | Bagged | Mean | SE | Mean | SE |
| Bunker Ck. | Cooler | Yes | 96.7 | 2.3 | 90.0 | 1.2 |
| Bunker Ck. | Cooler | No | 98.9 | 1.1 | 94.4 | 2.7 |
| Bunker Ck. | Freezer | Yes | 96.7 | 1.5 | 90.0 | 3.3 |
| Bunker Ck. | Freezer | No | 100.0 | 0.0 | 97.8 | 1.4 |
| Mima | Cooler | Yes | 98.9 | 1.1 | 97.8 | 1.4 |
| Mima | Cooler | No | 100.0 | 0.0 | 98.9 | 1.1 |
| Mima | Freezer | Yes | 98.9 | 1.1 | 98.9 | 1.1 |
| Mima | Freezer | No | 98.9 | 1.1 | 98.9 | 1.1 |

The percentage of trees with high vigor (Vigor 1+Vigor 2) was between 89.9% and 98.9% across sites and was slightly greater at Mima. Planting frozen seedlings did not significantly affect survival, vigor, or height growth, but planting trees with bags intact reduced height growth at both sites, although the reduction in height was not considered to be commercially significant.

Biomass allocation: Site and block exerted strong effects on stem diameter, top and root biomass allocation, and the root to shoot ratio. Trees at Mima were larger in every respect. Trees grown from frozen seedlings had slightly lower diameter and top dry weight, but not root dry weight or root/shoot ratio, than trees grown from seedlings that had not been frozen. The presence of a bag on the root mass reduced stem diameter and top dry weight, but not root system dry weight, or root/shoot ratio.

The experiments reported in this Example show that, one growth season after planting, the survival rate and vigor of Douglas fir seedlings planted while their root masses were frozen was almost identical to the survival rate and vigor of Douglas fir seedlings which had not been frozen, thereby supporting Null Hypothesis Hₒ(1). The experiments reported in this Example also show that packaging individual root masses in wax-coated paper bags, prior to freezer storage, facilitates separation of the individual plants at the planting site while the root masses remain frozen.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for storing tree seedlings, the method comprising the steps of:
(a) freezing a population of tree seedlings wherein each seedling within the population comprises a root mass that comprises roots and a growth medium, the roots being disposed within the growth medium, wherein the root mass is disposed within a container; and
(b) storing the frozen seedlings at a temperature at which the seedlings remain frozen.

2. The method of claim 1, wherein the tree seedlings are selected from the group consisting of Douglas fir, Western Hemlock, Noble fir, Western Red Cedar, Fraser fir, Canaan fir, Balsam fir, Grand fir, Red Alder, Sitka spruce and the genus Pinus.

3. The method of claim 1, wherein the growth medium is soil.

4. The method of claim 1, wherein the tree seedlings are frozen at a temperature in the range of from minus 1° C. to minus 5° C.

5. The method of claim 1, wherein the container is biodegradable.

6. The method of claim 5, wherein the biodegradable container is a bag.

7. The method of claim 6, wherein the bag is a paper bag.

8. The method of claim 6, wherein the bag is a wax-coated paper bag.

9. The method of claim 1, wherein the frozen seedlings are stored for a period of at least one month.

10. The method of claim 1, wherein the frozen seedlings are stored for a period of from one month to six months.

11. The method of claim 1, wherein the tree seedlings are stored at a temperature in the range of from minus 1° C. to minus 5° C.

12. The method of claim 1, wherein the growth medium comprises delayed-released fertilizer.

13. The method of claim 1, wherein the population of tree seedlings comprises at least one hundred thousand tree seedlings.

14. The method of claim 1, wherein the population of tree seedlings comprises at least one million tree seedlings.

15. The method of claim 1, wherein the population of tree seedlings comprises from one thousand tree seedlings to fifty million tree seedlings.
